(19) United States
(12) Patent Application Publication
(10) Pub. No.: US 2015/0379523 A1
(43) Pub. Date: Dec. 31, 2015

(54) System and Method for Exchanging and Updating Credentialing Information

(71) Applicant: Neeraj Sharma, Iselin, NJ (US)

(72) Inventor: Neeraj Sharma, Iselin, NJ (US)

(73) Assignee: Santéch Solution Inc., Iselin, NJ (US)

(21) Appl. No.: 14/851,656

(22) Filed: Sep. 11, 2015

(51) Int. Cl. G06Q 30/00

(52) U.S. Cl. CPC G06Q 30/018

(57) ABSTRACT

A computer system, and a computer-implemented method are provided for maintaining, providing and exchanging up to date credentialing information on a member to and from participant organizations. A database is maintained of credentialing information applicable to the member and obtained from credentialing organizations. Updates are managed to the member credentialing information, obtained through electronic network communications and synchronized with the credentialing organizations. The member credentialing information is updated, and synchronized with, participant organization systems of the participant organizations, on an automated basis.

### FIELD OF THE ART

The present subject matter generally relates to the field of collecting, storing and disseminating credentialing information. The subject matter has particular applicability, for instance, to health care professionals, who practice under color of credentials from academic institutions and licensing agencies.

### BACKGROUND OF THE INVENTION

The present subject matter contemplates the existence of differently situated parties, who will be referred to as “participant organizations,” “members,” and “credentialing organizations.” These terms are, by design, abstract in nature, and are intended to illustrate, at a broad level, the different needs and resources of these different parties. With these parties in mind, systems and methods according to the present subject matter will be understood in terms of how they interface with the three types of parties, so as to meet their needs.

One scenario will be discussed at length, for illustrative purposes without limitation. That scenario has to do with individual health care providers such as doctors, and with health care support and infrastructure organizations such as hospitals, medical practices, health maintenance organizations (HMOs), payor organizations and networks, and so forth. The doctors or other health care providers will have credentials, including academic degrees, board certifications, state licensing organization memberships, etc. They will have status and history of good standing, paid-up dues, disciplinary matters, etc. The health care support and infrastructure organizations, as a matter of good professional practice, establish and maintain records of the credentials for the individual health care providers. Once these credentials are established a practitioner is allowed to practice for the organization and the information is submitted to other participant organizations so they can establish similar credentials for the practitioner and handle visiting privileges and healthcare payments.

As defined in the preceding paragraph, the health care support and infrastructure organizations are deemed to be an example of “participant organizations,” and the individual health care providers are deemed to be examples of the “members.”

In order to function, participant organizations need to maintain complete and up-to-date records of the credentials of the members associated with them. Maintaining such complete and up-to-date records of the credentials can be a formidable administrative task. Maintaining these credentials is mandated compliance activity for these participant organizations to continue to provide care.

### DESCRIPTION OF THE PRIOR ART

Systems have been disclosed in the prior art that claim means for maintaining personnel data electronically. These include systems that have been patented and published in patent application publications. The foregoing is a list of systems deemed most relevant to the present disclosure, which are herein described for the purposes of highlighting and differentiating the unique aspects of the present invention, and further highlighting the drawbacks existing in the prior art.

Specifically, Geller, U.S. Patent Application Publication No. 2005/0117617 discloses a credentials record system that creates and maintains all personnel data electronically. The system archives data to create and record an audit trail of changes made by the users. The system also collects, verifies and stores data in a dynamic database. The system then analyzes data, including archived data, stored in the database to identify relationships and determine whether or not there are changes made, if any. Geller, however, does not disclose a system that generates extensible mark up language (XML) of all data elements, and that continuously maintains credentialing information up-to-date by identifying, tracking, notifying, and relaying the changes to providers and all stakeholders in an automated manner via algorithms.

Another reference, Newman, U.S. Patent Application Publication No. 2002/0161605 discloses a system and methods for selectively generating application forms for submittal by health care professionals to health care provider organizations. Physician credentialing profiles are stored into a system database together with various application forms. Based on the chosen application form, the system automatically fills out the application form using the information contained in the stored physician credentialing profiles. In this regard, the purpose and intent of the system disclosed in Newman differ significantly from the present invention in that Newman does not disclose a system maintains up-to-date credentialing information.

Similarly, Wiggins, U.S. Patent Application Publication No. 2006/0212315 discloses an information collection and processing system and related automated method for use by an organization providing health care. The system includes activity management system that manages, monitors or tracks the ongoing activity. The credential specialist determines if all required provider data is present and verified to complete record. In this regard, Wiggins does not disclose an automated system that can detect whether a provider's credentialing information is not updated via algorithms. Further, Wiggins does not provide the method steps of allowing a provider to validate or deny changes made to his or her credentialing profile.

Allen, U.S. Patent Application Publication No. 2003/0065626 discloses a method that provides biometric authentication of a user's identity and credential verification in performing a health-related transaction from a portable healthcare device. The credential service of the invention tracks the details of the user and checks for the level of the transaction access available to the user. Where the user identity is confirmed, the access server determines validity of credentialing information associated with a user. While Allen discloses a system that determines validity of credentialing information, Allen does not disclose a system that comprises dual modules, wherein each of the modules can be used to validate credentialing information.

Ibikunle, U.S. Patent Application Publication No. 2015/0019254 discloses an apparatus and method for improved authenticated access to personal health information. If the user is not pre-authorized, credentialing information is requested from the user. If the requested credentialing information collectively verifies the user is an authentic healthcare provider, the user may be provided permission to access a limited subset of the personal health information in a speedy manner despite not being pre-authorized. In this regard, the purpose and intent of the system as disclosed in Ibikunle differs from the present invention in that Ibikunle is focused on granting limited access to personal health information database whereas the present invention is focused on maintaining up-to-date credentialing information.

Accordingly, the systems disclosed in the prior art have several known drawbacks. Among other reasons, these systems are limited in that they are not automated and lack in security. More specifically, the foregoing references fail to disclose a system that continuously updates two modules that communicate with each other through a cloud interface for changes in a provider information, wherein the first module is deployed for hospitals and group practices, and the second module is deployed for payers/network, and further wherein all data elements are transmitted in XML. Additionally, the foregoing systems do not provide means for allowing a medical provider to track his or her own information in a personal web profile as his or her personal vault to review and approve changes initiated on their profile from any active node. Each node is relayed back with the provider's approval or denial for such information through XML files to make any corrections to the provider's profile.

Current systems and inventions require all participating organizations to seek these changes continuously from each other and members, which adds tremendous work load and industry effort waste. Due to lack of synchronization, most participating organizations end up maintaining minimum compliance, i.e., seeking and fixing these changes once every three years, instead of keeping these records up to date at all times. In a dynamic healthcare situation, where care management for a patient is handled among multiple healthcare professionals and all these healthcare professionals have a continued change in their information and credentials, it is desirable to have systems and inventions, which can seamlessly track these changes more frequently and notify all participating organizations for the changes so they can update their information with less efforts. In consideration of the systems now present in the prior art, the present invention provides an improved system and method for maintaining, providing and exchanging up to date credentialing information on a member to and from participant organizations.

### SUMMARY OF THE INVENTION

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

A computer system and a computer-implemented method are provided for maintaining, providing, comparing, and exchanging up to date credentialing information on a member to and from participant organizations. A database is maintained of credentialing information applicable to the member and obtained from credentialing organizations. Updates are managed to the member credentialing information, obtained through electronic network communications and synchronized with the credentialing organizations. The member credentialing information is updated, and synchronized with, participant organization systems of the participant organizations, on an automated basis.

It is therefore an object of the present invention to provide a system that allows providers to keep their credentialing information up-to-date continuously, and identify, track, and relay the changes to all stakeholders in an automated manner via algorithms.

It is another object of the present invention to provide a system that comprises a module that is available to clients for use as a standalone provider data management or as an add-on adaptor to existing legacy system managing provider information, and that can provide recruitment, credentialing, and payor enrollment functionalities for hospitals, group practices, and small practices.

It is still another object of the present invention to provide a system that provides multiple user roles, which allow users to securely access and enter information, perform business function, and interface with third party systems to import and export data.

It is still another object of the present invention to provide a system that generates XML of all data elements, which transmits data to databases securely over encryption.

It is still another object of the present invention to provide a system that can notify providers of all changes in their profile in an easy-to-understand and organized manner and that allows the providers to approve or deny the changes, wherein the approvals and denials are transmitted to entities that submitted the changes to make any corrections in the providers' profile.

A final object of the present invention to provide a system that includes a first module that is deployed for hospitals and group practices and a second module that is deployed for payers/network, wherein the two modules are continuously updated through a cloud interface for changes in a provider information.

In the light of the foregoing, these and other objects are accomplished in accordance of the principles of the present invention, wherein the novelty of the present invention will become apparent from the following detailed description and appended claims.

Further features and advantages of embodiments of the subject matter disclosed herein, as well as the structure and operation of preferred embodiments, are described in detail below with reference to the accompanying exemplary drawings.

### DESCRIPTION OF DRAWINGS

FIG. 1 is a system block diagram, showing an environment in which a system according to the present subject matter may be employed, and/or in which a method according to the present subject matter may be practiced.

FIG. 2 is a flowchart showing functionality of a credentialing information exchange system such as that shown in FIG. 1.

FIG. 3 is a flowchart showing registration of the parties of FIG. 1, to prepare a communication and registration infrastructure for supporting the functionality of FIG. 2 by the system of FIG. 1.

FIG. 4 is a system block diagram showing further details of the credentialing information exchange system of FIG. 1.

FIG. 5 is a system block diagram showing computer system components for supporting functionality of the system of FIG. 1.

### DETAILED DESCRIPTION

For the purposes of clarity, and not by way of limitation, illustrative views of the present invention are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, the use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. It is to be appreciated that determinations or inferences referenced throughout the subject specification can be practiced through the use of artificial intelligence techniques.

The present subject matter may be considered, from the standpoint of the exemplary situation involving health care providers, with their credentialing organizations and the institutions, which support their health care practices. Here are some of the credentials health care practitioners typically maintain, along with the credentialing organizations, which certify to those credentials for a given practitioner:
Graduation from Medical School
Primary source verification from the medical school.
Graduation from Internships, Residency's and Fellowships
Primary source verification from post-graduate education.
Board Certification
Primary source verification from The American Board of Medical Specialties.
Valid DEA certificate
Primary source verification from the DEA records certification.
Department of Health and Human Services
Medicare/Medicaid status
Primary source verification from DHHS Cumulative Sanction Report.
Current Valid License
Primary source verification of current license and sanction from the state licensing board.

Numerous different types of health care providers carry credentials related to their health care practices. These include physicians, dentists, pharmacists, physician assistants, nurses, advanced practice registered nurses, surgeons, surgeon's assistant, athletic trainers, surgical technologist, midwives (obstetrics), dietitians, therapists, psychologists, chiropractors, clinical officers, social workers, phlebotomists, occupational therapist, physical therapists, radiographer, respiratory therapists, audiologists, speech pathologists, optometrists, emergency medical technicians, paramedics, medical laboratory scientists, medical prosthetic technicians and a wide variety of other human resources trained to provide some type of health care service.

Such practitioners often work in hospitals, health care centers, and other service delivery points, but also in academic training, research, and administration. Some provide care and treatment services for patients in private homes. Community health workers work outside formal health care institutions. Managers of health care services, health information technicians, and other assistive personnel and support workers are also considered a vital part of health care teams. All of these institutions and organizations have an interest in having up-to-date knowledge of the credentials their health care practitioners carry.

Maintaining a complete and up-to-date record of credentials for any given health care practitioner is a challenge, whose scope may be seen from the following statistics: Each year, more than 20 percent of providers change their addresses, five percent change their status and 30 percent change their affiliations. At any time, more than three percent of physicians have disciplinary action. As a result, on average, 30 to 40 percent of the provider records maintained by payers, PPOs and other health care organizations contain errors or are missing data. Over 5 percent of claims can't be processed electronically because of poor provider data quality. Up to 15 percent of all correspondence and payments to providers are returned because of address errors. And the cost of fines and penalties resulting from non-compliance is staggering. In all, outdated or incorrect provider information costs health care payers over $26 billion every year.

More than 25 percent of health care provider contact information changes each year, which is why so many companies need help keeping the information up-to-date. When provider information is accurate, claims are processed more effectively, payments to health care providers are made more quickly, and important communications are received directly by their intended recipients, rather than being re-routed from incorrect or out-of-date addresses.

Many health plans are plagued by multiple disparate provider data systems, paper-based processes and a lack of coordination across business groups. These issues can not only lower efficiency, increase administrative costs and reduce provider satisfaction, but may impede plans' ability to flexibly structure their provider networks to deliver value in a dynamic marketplace. Health plans need an effective way to drive care delivery and reimbursement initiatives while helping to decrease costs and improve provider and member satisfaction.

Systems and methods according to the present subject matter address these needs by managing provider information and by streaming up-to-date information to other parties, and further by providing the following elements:
Allowing a full functional provider data management application for hospital/practices
Seamless solution from single provider practice to large multi location health system
Allowing ability to build third party information submission application (typically called participation or credentialing application) and routing them for e-signature
Building Provider profile by incoming files so a third party validated profile is built for Provider without need for data entry
Comparing Provider files on each incoming instance (submission to other organizations) and dynamically reviewing changes (note for Jim: Intercepting these files to compare and find changes)—allowing provider to accept reject changes
Relaying all approved changes to all stake holders—so all data files remains intact
Allowing Hospitals, Payors, and Networks to review all incoming changes from all sources in provider files (in Network visualization layer) and accept/reject feeds
Allowing Hospitals and Payors to send out recruitment and re-credentialing requests to Providers
Allowing Providers to accept recruitment requests and send out their information from their profile.

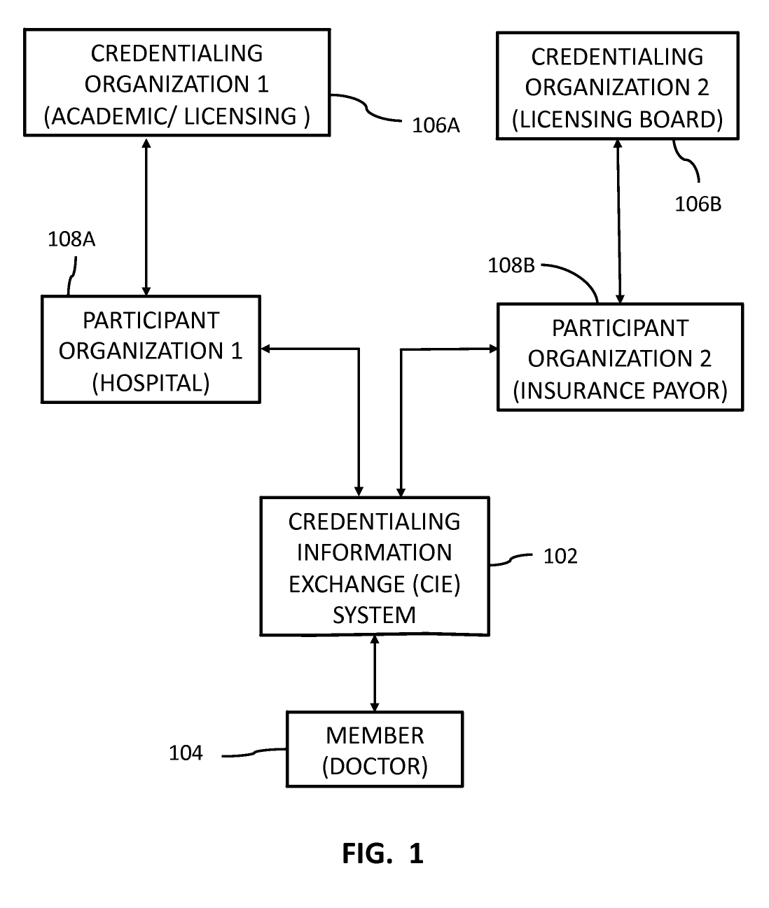

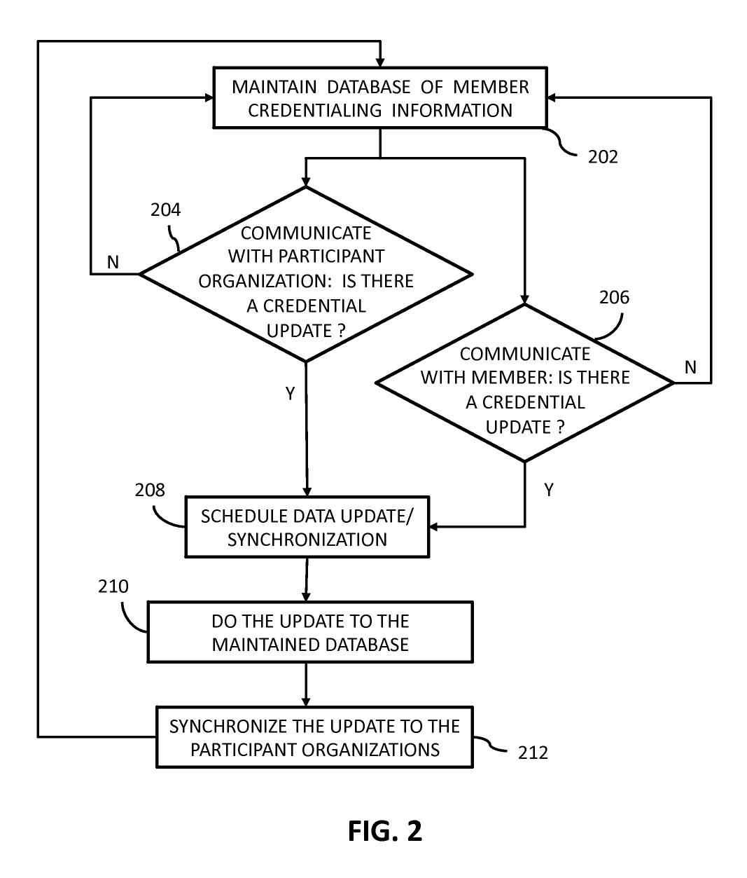

### Functional Environment; FIGS. 1 and 2

FIG. 1 is a high-level system block diagram, showing the various entities/parties that are involved in the operation of a system according to the present subject matter. The blocks are defined in terms of the relatively abstract entity designations given above, for appropriate breadth of scope of description. For the reader's convenience, parentheticals are also given, showing concrete examples, which are to be discussed in connection of the description of examples of the present subject matter. It will be understood that the parentheticals, and the accompanying text description, are for illustrative purposes only, and are not limiting.

A credentialing information exchange (Provider Information Exchange or Provider Network Information Exchange) system (hereinafter “CIE system”), according to the present subject matter, is shown as 102 in FIG. 1. This will be described in detail below, as to its structural architecture and its functionality. The CIE system 102 may be implemented as a computer system, with suitable structural components and functionality. Interfaces, for coupling to peripheral devices, communication lines, etc., are shown schematically.

A member 104 is shown. The member 104, may, for instance, be a doctor having a medical degree, a license to practice in one of more states, a membership in good standing of a state medical board, and a record of disciplinary actions (if any), etc. The foregoing are non-limiting examples of credentials that such a member 104 might have. The credentials are subject to change as time progresses. For instance, a state board membership may be subject to timely payment of annual dues, or may be suspended pending the outcome of a disciplinary investigation.

The CIE system 102 is coupled, for instance through a coupling adaptor working at participant organization 108A, 108B, which has a communication network, to one or more credentialing organizations; or more specifically to computer systems maintained by the credentialing organizations. A first credentialing organization, shown as 106A, may for instance be an academic institution that awarded a degree to the member 104. A second credentialing organization, shown as 106B, may for instance be an academic institution that licensed the member 104 to practice medicine.

Finally, FIG. 1 shows parties herein designated as participant organizations 108A and 108B. A participant organization may broadly be defined as any party, which has an interest in possessing up-to-date knowledge of a member's credentials. For instance, a first participant organization 108A may be a hospital that may employ the member 104 as a staff doctor, with admitting and practicing privileges. A second participant organization 108B, shown for instance as an insurance payor (that is, an insurance company that offers patient policies and pays for covered medical expenses), may wish to verify that the incurred charges it is paying, were in fact incurred from a suitably credentialed doctor.

From the description of FIG. 1, it will be seen that the participant organizations 108A and 108B have independent processes for accessing up-to-date credentialing information for the member 104, from the credentialing organizations 106A and 106B. Given with changing nature of provider information only way an entity like 108A and 108B can be sure about accuracy and compliance of its information if it communicates regularly among each other and with the credentialing organizations 106A and 106B, to maintain up-to-date contact information from these credentialing organizations. Also, the participant organizations 108A and 108B must communicate regularly with the member 104, to learn whether or not the member 104 has any new or changed credentials. This adds up to a considerable, and ongoing, administrative burden for the participant organizations 108A and 108B. It also imposes a regular burden on the member 104, as well as the credentialing organizations 106A and 106B.

In accordance with an embodiment of the present subject matter, the CIE system 102 unburdens the other mentioned entities and systems of the requirement for communication to maintain up-to-date credentialing information. The CIE system 102 communicates with the participant organizations 108A and 108B, and with the member 104, to identify any changes to the credentials for the member 104, which they have identified from sources 106A, 106B at any point of time.

In another embodiment, the present system allows participant organizations to send out a request to other participant organizations to seek credentialing information updates during the re-credentialing process. In this regard, the participant organization 108B, such as a payor or network can seek information about the member 104 from another participant organization 108A. When the participant organization 108B generates a request within its I-Network system, automated analyses will be performed at the CIE system 102 to route the request to another participant organization 108A using appropriate network connection, client node, and user access. When another participant organization 108A receives the request in its I-Enroll module, it can respond to the request with all supporting documents and information through the CIE system 102. This process will again perform automated analyses to find connection details and relationship nodes for the member 104 and allow the member 104 to securely access the web user interface to electronically sign submitted document. The document is then routed to the participant organization 108B, wherein the participant organization 108B is the entity that requested the information for re-credentialing purposes.

The CIE system 102 functions, at a high level, as shown in the flowchart of FIG. 2.

The CIE system 102 maintains (202) a database of member credentialing information. Doing so may include establishing existing relations with members such as 104, and with participant organizations such as 108A and 108B. The existing relations may be created by a suitable means such as subscriptions or during the completion of a transaction such as completion and e-signature of an application. Once a relation is established, the members and the participant organizations share a virtual communication path of Internet URLs, or other network addresses, to allow for network communication to take place without requiring direct human intervention at the time. Also, schedules can be defined for communications. For instance, the communication may take place at regular time intervals, or may be driven either by credential updates on the part of the member, or by user requests initiated by human operators either for the members or for the participant organizations.

These various ways of initiating communication are shown schematically, in the flowchart of FIG. 2, as being queries as to whether a participant organization has an update for the member 104 (204). The query 204 shown in FIG. 2 may represent a communication initiated by a participant organization to submit a transaction to other participant organization and that contains changes in or new information about the member 104. The changes or new information, for instance, may include receipt by the member 104 of an advanced degree from an academic institution, the payment of annual licensing dues to renew membership in good standing, or the institution of a disciplinary matter by a state licensing board.

Likewise, the flowchart query 206 of FIG. 2 represents a communication with the member 104, which could either be a routine update query initiated by the CIE system 102, or by the member 204 to report that he/she has a new credential.

In response to any detected communication, the CIE system 102 schedules (208) update and data synchronization with the participant organizations, or with the member 104, as appropriate. Scheduling, as used here, can mean establishing communication immediately, or treating the communication as an agenda item for a regularly scheduled communication, etc.

The communication just mentioned is used for the purpose of establishing the up-to-date information, which is then used to update (210) the database maintained by the CIE system 102. It is contemplated that each communication or data comprising existing credentials or updated credentials comprise a data stamp so that data stamps can be compared to determine whether updates exist. Then, the updated information is synchronized (212) to all of the participant organizations that are associated with the member 104.

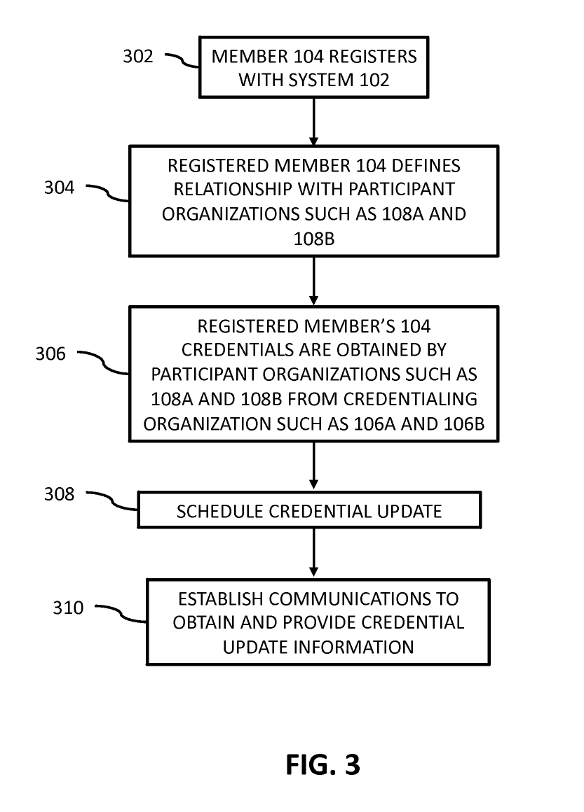

### Registration; Subscription of Members, Participant Organizations, and Credentialing Organizations: FIG. 3

As discussed above in connection with step 202 of FIG. 2, it was mentioned that existing relations are established with the member 104 and participant organizations such as 108A and 108B. FIG. 3 is a flowchart generally showing how such registration may be created and maintained.

To establish such a registration, the member 104 registers (302) with the CIE system 102. Registration may include self-registration or user invite by participant organization by providing profiling information, such as electronic or hard-copy addresses for communication, login information for a networked computer or communication appliance, etc.

Registration also includes defining a credentialing relationship (304) between the member 104 and participant organizations 108A and 108B. As part of defining (304) the relationship with such participant organization, information required for electronic communication is provided. This again may include a communication network address, login password, account information for the member 104, etc. Accordingly, the CIE system 102 and the participant organizations 108A and 108B can communicate electronically. In an embodiment, such communication may be initiated and conducted automatically.

A participant organization can, for instance, be an employer or professional association, such as the hospital 108A where the member (doctor) 104 practices. Where such a participant organization 108A represents to the public that the member 104 practices under the participant organization's auspices, the professional organization 108A has reason to want to verify the member's 104 credentials.

A participant organization can alternatively, for instance, be a payor of costs incurred by customers (such as patients) who receive services such as medical care from the member 104. Such a payor may, for instance, be the insurance payor 108B. Since such a participant organization 108B is liable for payment for the services rendered by the member 104, it also has reason to want to verify the member's 104 credentials.

Once a credentialing relationship between the member 104 and participant organizations 108A and 108B are defined (304), the registered member's 104 credentials are obtained by the participant organizations 108A, 108B from credentialing organizations 106A, 106B (306). In this way, the member's 104 credentials are distributed in a controlled manner to valid participant organizations. Additionally, the present system eliminates the need for the members to directly provide their credentialing information to the participant organizations.

The flowchart of FIG. 3 further includes the step of scheduling (308) an update. This flowchart step is a concise representation of a function, which may be performed multiple different ways.

In one embodiment, an update may be performed automatically, according to a regular schedule. This may be done, for instance, by programming the member's 104 profile in the CIE system 102 to operate according to a prearranged schedule, for instance at regular intervals.

In another embodiment, a credential update may be performed responsive to a message from the member 104, indicating that a new credential, such as the acquisition of a new state license, has occurred. For the purpose of illustrating the flowchart of FIG. 3, the expression “schedule credential update” (308) is understood to encompass such a message-driven credential update, as well. Responsive to such a message from the member 104, the CIE system 102 establishes communications (310) to check the credentialing organizations 106A and 106B for any updates, to determine whether any additional credential updates are pending. The CIE system 102 updates the member's 104 profile accordingly, and then communicates the updated credentialing information to the participant organizations 108A and 108B.

In yet another embodiment, a credential update may be performed responsive to a message from one of the credentialing organizations 106A or 106B, indicating that there has been a change of credential status, such as payment of annual dues for an existing state license or the suspension of an existing state license. Responsive to such a message from the credentialing organizations 106A or 106B, the CIE system 102 establishes communications (310) to check the member 104 and all other credentialing organizations for any updates, to determine whether any additional credential updates are pending. The CIE system 102 updates the member's 104 profile accordingly, and then communicates the updated credentialing information to the participant organizations 108A and 108B.

In still another embodiment, a credential status query may be performed responsive to a message from any one of the parties shown in FIG. 1. Responsive to a message-driven credential query from a party, the CIE system 102 establishes communications (310) to check the member 104 and all credentialing organizations for any updates, to determine whether any credential updates are pending. The CIE system 102 updates the member's 104 profile if necessary, and then to communicate the updated credentialing information to the party, which made the inquiry. If a credential status update had been ascertained, then the other parties are notified accordingly.

For all of the above-described embodiments, it will be understood that communications between the CIE system 102 and all other parties shown in FIG. 1 and described in connection with any of the above embodiments, may take place automatically, without human intervention, using the communication information stored in the member's 104 profile, and provided for the respective parties when registration took place. Accordingly, all information required to establish communication and exchange information with the network communication systems of the respective parties may take place automatically.

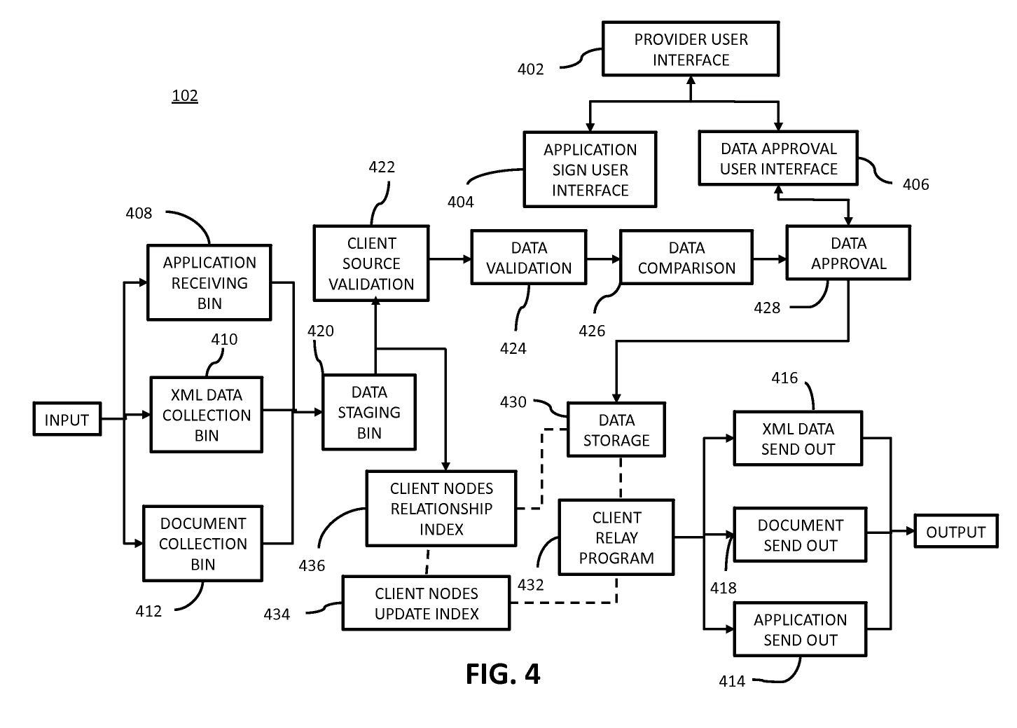

### Detailed Block Diagram of the CIE System 102—FIG. 4

FIG. 4 is a detailed block diagram showing structural and functional details of an embodiment of the CIE system 102. In this particular embodiment, communication technology available under the commercial trade name “I-NetXchange” may be employed.

A provider user interface 402 serves as a communication interface to the member 104. The provider user interface 402 may include, as functional components, an application sign user interface 404 and a data approval user interface 406. The data approval user interface may serve to provide the member 104 with notice of a credential update received from a credentialing organization, and to give the member 104 a chance to approve the credential update, or to inquire separately about the credential update with the credentialing organization which sent out the credential update.

Interfaces between the CIE system 102 and the credentialing organizations 106A and 106B, as well as the participant organizations 108A and 108B, are bidirectional, and include receivers which may comprise an application receiving bin 408, an XML data collection bin 410, a document collection bin 412, and/or other suitable data collection bins. Likewise, the bidirectional interfaces also each include an application output bin 414, an XML data output bin 416, and/or a document output bin 418.

Messages and data received from one of the participant organizations or the credentialing organizations are routed to a data staging bin 420. From there, the message or data is validated at a client source validation module 422, which confirms the identity of the participant or credentialing organization. For instance, a message from a credentialing or participant organization that is not registered with the profile of the member 104 may be flagged as an error.

After the source of the data or message is validated, the data itself is validated via a data validation module 424. Data validation 424 can include verifying content and syntax of the data or message, verifying that the message includes a credential update, credential status request, or the like, and that a credential update is valid. For instance, a message indicating payment of annual dues is applicable to a membership requiring such dues, but not relevant to an academic degree.

Data pertaining to a validated credential for the member 104 is then compared with the credential data of record via a data comparison module 426. If the data represents a valid change of credential status, then it may be sent to the member 104 for approval. If the data is approved (428) by the member 104 for storage (430) in the member's 104 database, then it is transmitted as a credential update to the registered participant organizations.

The approved data representing a valid change of credentialing information may, in an embodiment, be treated as follows: Data is provided to a data relay program 432, which provides the data to the various outputs 416, 418, and/or 420, for each of the other parties of FIG. 1, such as the participant organizations, etc. From there, the data is transmitted as a credential update to the other parties, using the network communication addresses, login information, etc., as described above.

The data is also provided to a client nodes update index 434 for update logging, and to produce and maintain historical records of credentialing changes. A client nodes relationship index 436 is employed to check which party has control over updating a credential. For instance, depending on how the member's 104 profile characterizes a given credentialing organization, either one of those two parties may have ultimate authority over how a credentialing change is to be handles. Either the credentialing change goes out to the other parties automatically, or the member 104 controls if and when it is to be sent out.

Note, incidentally, that the client nodes relationship index 436 also communicates with the client source validation module 422 for verifying that a received credentialing update is from a valid credentialing organization, or from the member 104.

### A Scenario for Operation

The following list of events may be considered a more concrete example of the functionality of FIG. 3, and then FIG. 2, in a realistic scenario involving doctors, hospitals, etc. In this scenario, the functionality of the system, as more generally shown in the flowcharts of FIGS. 3 and 2, is designated by the term “I-Enroll,” which might be deemed to be the commercial trade name of such a product/service offering.
I. Step 1: A hospital or practice obtains I-Enroll either as license or as an online subscription of a web offering such as a website (e.g., www.myienroll.com), a web application, and the like.
II. Step 2: The hospital or practice starts using I-Enroll to manage information for a provider (e.g., Dr. John Smith). The following methods are non-limiting examples of methods for entering information relating to the providers in the system.
   a. Information relating to the provider can be manually entered into the system by a staff at the hospital or practice.
   b. The provider, Dr. John Smith, can enter his own information via an online portal such as the website.
   c. Information relating to the provider is automatically imported from third party sources using an import tool such as one available under the commercial trade name “I-Exchange.”
III. Step 3: The provider's information is reviewed so that it can be verified internally (e.g., as per credentialing process used in “I-Verify”) and pre-populated in payors' specific applications. These applications are submitted for electronic signature using an online tool such as one available under the commercial trade name “I-NetXchange.”
IV. Step 4: A data file containing all data elements and documents is relayed to I-NetXchange and a provider profile is created for Dr. John Smith, for example, on a website. It is contemplated that the data file may be in an Extensible Markup Language (XML) file format, but it may be in other formats, depending upon embodiment. Once the provider profile is created, a notification such as an email notification or a SMS notification will notify Dr. John Smith to come verify the profile. The notification may contain a direct link to the profile.
V. Step 5: To verify a provider profile, the provider, e.g., Dr. John Smith, is required to sign in to his profile. Optionally, the provider may review all the incoming information to ensure all accurate documents and data elements are included in his or her profile. To complete verifying the provider profile, the provider must electronically sign at a verification page on the website for submission.
VI. Step 6: Each time the Dr. John Smith's information is transmitted for e-signature by the same entity or any other entity, the file is compared against the existing data set residing on the provider's profile and all changes are notified to Dr. John Smith for his approval or denial.
VII. Step 7: All acceptance and rejection provided by Dr. John Smith are relayed back to submitting entities and other parties who are using Dr. John Smith's information so they can make correction in their provider files.

### Additional Features

I. The provider is given the option to specify where to report any changes or updates to his or her profile. For instance, Dr. John Smith may make changes to his profile and relay the updated information to one entity without worrying about relaying information to all of the entities in communication with his profile.
II. Any updates made to a provider's profile by the profile owner (i.e., the provider), including any updated or new documents uploaded on his profile can be transmitted to all of the entities in communication with his profile.
III. A practice, hospital, and/or a recruiter can send out a recruitment request to a provider based on his or her credentials specified on his or her profile. Upon receiving a recruitment request, the provider can accept it and transmit information from his profile, including any relevant documents to the recruiting entity.
IV. Payors can send network recruitment requests to all providers or a selected group of providers working under a practice or a hospital.

### System Block Diagram

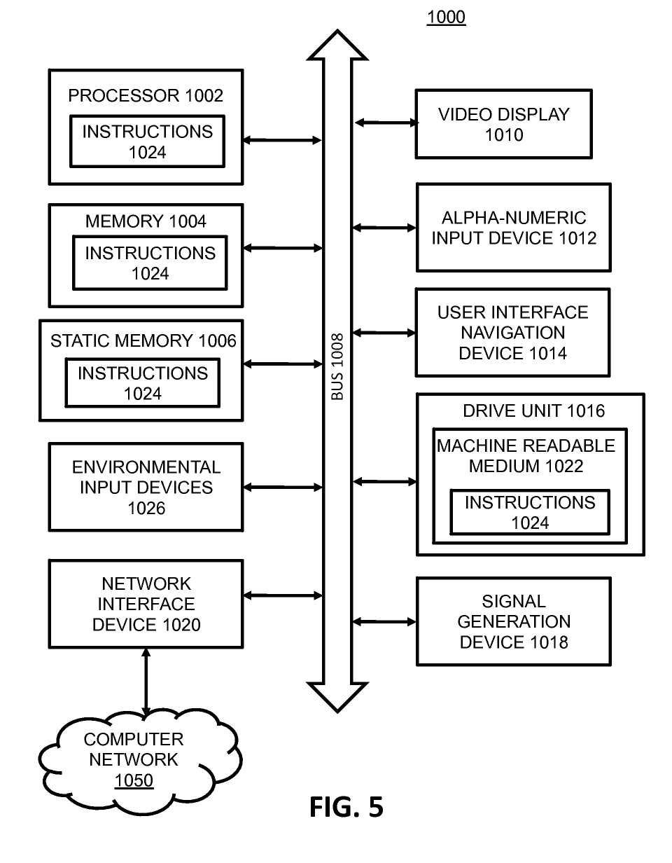

FIG. 5 is a block diagram of a machine in the example form of a computer system within which instructions for causing the machine to perform any one or more of the methodologies discussed herein may be executed.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker), and a network interface device 1020. The computer system 1000 may also include a environmental input device 1026 that may provide a number of inputs describing the environment in which the computer system 1000 or another device exists, including, but not limited to, any of a Global Positioning System (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 1024 may further be transmitted or received over a computer network 1050 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java or Enterprise Java. Much functionality described herein can be implemented in computer software, computer hardware, or a combination.

Furthermore, a computer that is running the previously mentioned computer software can be connected to a network and can interface to other computers using the network. The network can be an intranet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al). In one example, signals from the computer can be transferred, at least in part, wirelessly to components or other computers.

It is to be understood that although various components are illustrated herein as separate entities, each illustrated component represents a collection of functionalities, which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the present subject matter may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the present subject matter or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the present subject matter can be implemented as software, hardware, firmware or any combination of the three. Of course, wherever a component of the present subject matter is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present subject matter is in no way limited to implementation in any specific programming language, or for any specific operating system or environment.

Furthermore, it will be readily apparent to those of ordinary skill in the relevant art that where the present subject matter is implemented in whole or in part in software, the software components thereof can be stored on computer readable media as computer program products. Any form of computer readable medium can be used in this context, such as magnetic or optical storage media. Additionally, software portions of the present subject matter can be instantiated (for example as object code or executable images) within the memory of any programmable computing device.

As will be understood by those familiar with the art, the present subject matter may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the present subject matter or its features may have different names, divisions and/or formats.

Accordingly, the disclosure of the present subject matter is intended to be illustrative, but not limiting, of the scope of the present subject matter, which is set forth in the following claims.

1. A system for directing a computer system to maintain, provide and exchange up to date credentialing information on a member to and from participant organizations, the system comprising:
network communication interfaces for coupling with a member, a credentialing organization, and a participant organization;
a database for storing a member profile including a record of member credentialing information, a credentialing organization record of the credentialing organization which maintains the record of member credentialing information, the credentialing organization record including information for establishing network communication with the credentialing organization, and a participant organization record of the participant organization which desires to maintain an up-to-date version of the record of member credentialing information, the participant organization record including information for establishing network communication with the participant organization;
a client source validation module for receiving a credential update message for the member, verifying a sender information and a content of the credential update message, and storing the credential update message in the member profile; and
a data relay program for establishing network communication with the participant organization and for sending the credential update message thereto.

2. The system of claim 1, further comprising a client nodes update index, wherein the client nodes update index is configured to log updates to the record of member credentialing information, thereby producing and maintaining historical records of changes to the record of member credentialing information.

3. The system of claim 1, further comprising a client nodes relationship index, wherein the client nodes relationship index communicates with the client source validation module for verifying that a received credential update message comprises a credentialing update from a valid credentialing organization, or from the member.

4. The system of claim 1, wherein the database comprises an application receiving bin, a XML data collection bin, and a document collection bin;
each of the application receiving bin, the XML data collection bin, and the document collection bin in communication with a data staging bin, wherein the data staging bin transmits the credential update message to the client source validation module.

5. A non-transitory computer-readable recording medium, comprising:
instructions for communicating with an application receiving bin, a XML data collection bin, and a document collection bin via a web services component to receive a member credentialing information;
instructions for maintaining a database of the member credentialing information that has been verified and approved;
instructions for receiving a credential update message for the member, verifying a sender information and a content of the credential update message, and storing the credential update message in a member profile, upon receiving a communication from a client source validation module, wherein the content of the credential update message comprises incoming credentialing information;
instructions for comparing the member credentialing information with the incoming credentialing information of a member to determine whether there are updates to the member credentialing information, wherein the incoming credentialing information is transmitted by the member or the credentialing organization, further wherein the updates are verified by the credentialing organization, further wherein the updates are approved by the member via a provider user interface;
instructions for transmitting the incoming credentialing information of the member to participant organizations on an automated basis.

6. The non-transitory computer-readable recording medium of claim 5, further comprising instructions for establishing a bidirectional communication between the member, the credentialing organization, and the participant organizations.

7. The non-transitory computer-readable recording medium of claim 5, wherein the member comprises a health care provider.

8. The non-transitory computer-readable recording medium of claim 5, wherein the participant organizations comprise health care providers, hospitals, medical practices, dental practices, health maintenance organizations (HMOs), health insurance companies, dental insurance companies, vision insurance companies, and provider network organizations.

9. The non-transitory computer-readable recording medium of claim 5, wherein each of the member credentialing information and the incoming credentialing information comprises a health care provider's demographic information, practicing location, state license, federal license, DEA registration, certification, education, past employment, and practice specialty.

10. The non-transitory computer-readable recording medium of claim 5, further comprising:
instructions for identifying the updates based on a data stamp associated with each of the member credentialing information and the incoming credentialing information;
instructions for recording the updates on the member profile, wherein the updates comprise incoming credentialing information.

11. The non-transitory computer-readable recording medium of claim 5, further comprising:
instructions for flagging the updates to the participant organizations; and
instructions for receiving approval for the updates, upon receiving a communication from the participant organizations.

12. The non-transitory computer-readable recording medium of claim 5, further comprising:
instructions for transmitting the member credentialing information to the participant organizations upon receiving recruitment requests from the participant organizations; and
instructions for receiving revalidation of the member credentialing information on the database at regular intervals, upon receiving a communication from the member.

13. A computer-implemented method for maintaining, providing and exchanging up to date credentialing information on a member to and from participant organizations, the method comprising:
communicating with an application receiving bin, a XML data collection bin, and a document collection bin via a web services component to receive a member credentialing information;
maintaining a database of the member credentialing information that has been verified and approved;
receiving a credential update message for the member, verifying a sender information and a content of the credential update message, and storing the credential update message in a member profile, upon receiving a communication from a client source validation module, wherein the content of the credential update message comprises incoming credentialing information;
comparing the member credentialing information with the incoming credentialing information of a member to determine whether there are updates to the member credentialing information, wherein the incoming credentialing information is transmitted by the member or the credentialing organization, further wherein the updates are verified by the credentialing organization, further wherein the updates are approved by the member via a provider user interface;
transmitting the incoming credentialing information of the member to participant organizations on an automated basis.

14. The method as recited in claim 13, further comprising the steps of establishing a bidirectional communication between the member, the credentialing organization, and the participant organizations.

15. The method as recited in claim 13, wherein the member comprises a health care provider.

16. The method as recited in claim 13, wherein the participant organizations comprise health care providers, hospitals, medical practices, dental practices, health maintenance organizations (HMOs), health insurance companies, dental insurance companies, vision insurance companies, and provider network organizations.

17. The method as recited in claim 13, wherein each of the member credentialing information and the incoming credentialing information comprises a health care provider's demographic information, practicing location, state license, federal license, DEA registration, certification, education, past employment, and practice specialty.

18. The method as recited in claim 13, further comprising the steps of:
identifying the updates based on a data stamp associated with each of the member credentialing information and the incoming credentialing information;
recording the updates on a member profile, wherein the updates comprise incoming credentialing information.

19. The method as recited in claim 13, further comprising the steps of:
flagging the updates to the participant organizations; and
receiving approval for the updates, upon receiving a communication from the participant organizations.

20. The method as recited in claim 13, further comprising the steps of:
transmitting member credentialing information to the participant organizations upon receiving recruitment requests from the participant organizations; and
receiving revalidation of the member credentialing information on the database at regular intervals, upon receiving a communication from the member.
